(19) United States
(12) Patent Application Publication
(10) Pub. No.: US 2008/0292863 A1
(43) Pub. Date: Nov. 27, 2008

(54) SILOXANE POLYMER, PREPARATION METHOD THEREOF, POROUS-FILM FORMING COATING SOLUTION CONTAINING THE POLYMER, POROUS FILM, AND SEMICONDUCTOR DEVICE USING THE POROUS FILM

(75) Inventors: Fujio Yagihashi, Joetsu-shi (JP); Yoshitaka Hamada, Joetsu-shi (JP); Takeshi Asano, Joetsu-shi (JP); Motoaki Iwabuchi, Joetsu-shi (JP); Hideo Nakagawa, Shiga (JP); Masaru Sasago, Osaka (JP)

Correspondence Address: MYERS BIGEL SIBLEY & SAJOVEC, PO BOX 37428, RALEIGH, NC, 27627, US

(73) Assignees: Shin Etsu Chemical Co., Ltd.; Matsushita Electric Industrial Co., Ltd.

(21) Appl. No.: 12/029,566

(22) Filed: Feb. 12, 2008

(30) Foreign Application Priority Data
Feb. 16, 2007 (JP) 2007-036344

(51) Int. Cl. B32B 3/26; C08G 77/26; C08G 77/08

(52) U.S. Cl. 428/304.4; 528/37; 528/21; 427/387; 438/780

(57) ABSTRACT

Provided is a method for preparing a siloxane polymer by hydrolysis and condensation reactions of a hydrolyzable silane compound, which has a step of preparing a salt of a silsesquioxane cage compound represented by the following formula (1):

(SiO_{1.5}—O)ₙⁿ⁻X⁺ₙ (1)

wherein, X represents NR₄, Rs may be the same or different and each represents a linear or branched C₁₋₄ alkyl group and n is an integer from 6 to 24 and a step of hydrolyzing and condensing the hydrolyzable silane compound with the salt of a silsesquioxane cage compound.

### CROSS-RELATED APPLICATIONS

This application claims priority from Japanese Patent Application No. 2007-036344; filed Feb. 16, 2007, the disclosure of which is incorporated herein by reference in its entirety.

### BACKGROUND OF THE INVENTION

1. Field of the Invention

The present invention relates to a siloxane polymer capable of providing a porous film having improved mechanical strength without impairing a low dielectric constant, a film forming composition containing the siloxane polymer, a formation method of a porous film using the film forming composition, a porous film formed thereby, and a semiconductor device having therein the porous film.

2. Description of the Related Art

In the fabrication of semiconductor integrated circuits, as their integration degree becomes higher, an increase in an interconnect delay time due to an increase in interconnect capacitance, which is a parasitic capacitance between metal interconnects, prevents their performance enhancement. The interconnect delay time is called an RC delay which is in proportion to the product of the electric resistance of metal interconnects and the static capacitance between interconnects. Reduction in the resistance of metal interconnects or reduction in the capacitance between interconnects is necessary for reducing this interconnect delay time. The reduction in the resistance of an interconnect metal or interconnect capacitance can prevent even a highly integrated semiconductor device from causing an interconnect delay, which enables miniaturization and high speed operation of the semiconductor device and moreover, reduction of power consumption.

In order to reduce the resistance of metal interconnects, copper interconnects have recently replaced conventional aluminum interconnects. Use of copper interconnects alone, however, has limits in accomplishing performance enhancement so that reduction in the interconnect capacitance is an urgent necessity for further performance enhancement of semiconductor devices.

One method for reducing interconnect capacitance may be to decrease dielectric constant of an interlayer insulating film disposed between metal interconnects. As such a low-dielectric-constant insulating film, a porous film is now studied instead of a conventional silicon oxide film. In particular, since a porous film is only one practical film as a material having a dielectric constant of 2.5 or less, which is required for an interlayer insulating film, various methods for forming a porous film have been proposed. When an interlayer insulating film is made porous, however, reduction in mechanical strength and adsorption of moisture tend to deteriorate the film so that reduction in dielectric constant (k) by introduction of pores into the film and maintenance of sufficient mechanical strength and hydrophobicity are big challenges to be solved.

For satisfying both introduction of pores and sufficient mechanical strength, proposed is a method of introducing zeolite or zeolite-like structure, as ultimately hard particles, into a film to raise its strength or forming crystals to reduce remaining silanol groups, thereby maintaining sufficient hydrophobicity. For example, California University/USA proposes a method for forming a zeolite film (silica zeolite film having an MFI crystal structure) on a semiconductor substrate by using a suspension obtained by separating and removing particles of a relatively large particle size from zeolite fine particles obtained by hydrolysis, in the presence of tetrapropylammonium hydroxide (TPOAH), of tetraethylorthosilicate (TEOS) dissolved in ethyl alcohol (refer to, for example, US Patent Application Publication No. 2002/0060364 A1, Advanced Material, 13, No. 19, 1453-1466 (2001)). Although the zeolite film obtained by the above-described method has a Young's modulus of 16 to 18 GPa, it cannot be suited for practical use because due to high hygroscopicity of the film, it absorbs atmospheric moisture and drastically raises its dielectric constant. There is therefore proposed a method of keeping a dielectric constant of the film to from 2.1 to 2.3 by silane treatment for making the film surface hydrophobic.

There is also proposed a method for heightening the strength by using zeolite particles/zeolite-like particles and an alkoxysilane hydrolysate in combination (refer to, for example, Japanese Patent Provisional Publication No. 2004-153147). In this method, zeolite particles or zeolite-like particles are formed first and they are mixed with the alkoxysilane hydrolysate, optionally followed by a ripening reaction. The method for forming crystalline zeolite thus requires such a complex operation.

A synthesis method of zeolite having a low impurity content and suitable for a use in semiconductor devices as described above is very cumbersome. There are many attempts to obtain a low-dielectric-constant film by using a silicon oxide-based polymer which is advantageous to an industrial process application compared to zeolite. For example, in Japanese Patent Provisional Publication No. 2004-149714, recommended is a method for improving a pore density of a film by using a large amount of tetrapropylammonium hydroxide acting as a structure-directing agent upon synthesis of zeolite to partially form a zeolite-like structure, thereby forming zeolite-like micropores in the film during film formation.

The present inventors also proposed a method for preparing a silica material having high strength by using a quaternary ammonium salt of silicic acid for preventing incorporation of an alkoxy group in silica which will otherwise occur due to the progress of condensation reaction in spite of insufficient hydrolysis at the initial stage of the reaction (refer to, for example, Japanese Patent Provisional Publication No. 2004-292642).

The film strength itself depends on not only the physical properties of a material used for a film forming composition but also the behaviors of the material during film formation. According to the report (refer to, for example, Japanese Patent Provisional Publication No. 2005-216895) by the present inventors, a high strength film can be formed by the steps of: modifying a surface of a siloxane polymer or a zeolite particle with a crosslinking group having a high crosslinkability between particles or between a particle and a silicon-oxide-based resin to be added simultaneously; temporarily losing the crosslinkability with a protective means for preventing the crosslink formation or deactivation of the crosslinking groups during stable storage; and sintering after application for removing the protective means and developing the crosslinkability again.

### SUMMARY OF THE INVENTION

A siloxane polymer can be prepared far easier than zeolite so that it is a preferable material for industrial uses. When it is used as a material for having pores in a film, however, it may be principally apparent that particles cannot have high pore density and the particles themselves have much inferior mechanical strength to zeolite. The dielectric properties and mechanical strength properties of a whole film may be not necessarily determined by the porosity and mechanical strength of particles alone. The present inventors experience some examples during a number of attempts that some films, even in a case of using a siloxane polymer, can have unexceptionally high mechanical strength without impairing its dielectric properties. It is expected that there may be a new material capable of providing a porous film superior in low-dielectric-constant properties to that of a known siloxane polymer instead of using a zeolite.

An object of the invention may be to provide an industrially advantageous siloxane polymer obtained by a new synthesis method capable of forming a porous film superior in mechanical strength to that of a conventional siloxane polymer, a film forming composition containing the siloxane polymer, a method of forming a porous film, and a porous film formed by the method.

Another object of the invention may be to provide a high performance and high reliability semiconductor device having therein a porous film formed using the above-described advantageous material.

The present inventors have repeated a number of trial and error attempts to seek a siloxane polymer material capable of providing a porous film excellent in both dielectric properties and mechanical strength. As one of the attempts, they synthesize a siloxane polymer by using, as a starting material, a silsesquioxane cage compound in which an acid silanol group bonds to each vertex of silicon atoms and forms a salt with a quaternary ammonium as a counter cation and by carrying out hydrolysis and condensation reactions of a hydrolyzable silane compound with the compound. A porous film is formed by applying a porous-film forming composition containing the siloxane polymer to form a thin film and then sintering the resulting thin film. As a result, it has been found that the porous film has higher mechanical strength than that of a film formed using a conventional material without impairing a low dielectric constant, leading to the completion of the invention.

A method of reacting a quaternary ammonium salt of silanol with a hydrolyzable silane compound is already disclosed in Japanese Patent Provisional Publication No. 2004-292642. The improvement in mechanical strength achieved by the invention cannot be explained by the details disclosed in such document, however, it may utilize an effect derived from a special structure of the silsesquioxane cage compound.

In one aspect of the invention, there is thus provided a method for preparing a siloxane polymer by hydrolysis and condensation reactions of a hydrolyzable silane compound, which comprises the steps of: preparing a salt of a silsesquioxane cage compound represented by the following formula (1):

(SiO_{1.5}—O)ₙⁿ⁻X⁺ₙ (1)

(wherein, X represents NR₄, Rs may be the same or different and each independently represents a linear or branched C₁₋₄ alkyl group and n is an integer from 8 to 24) or an aqueous solution of the salt; and then hydrolyzing and condensing the hydrolyzable silane compound to the silanol terminal of the silsesquioxane cage compound. The salt of the cage compound may serve as a catalyst for condensation reaction of the hydrolyzable silane compound and at the same time become a nucleus of silica particles. A porous film available from a porous low-dielectric-constant material composition containing the siloxane polymer obtained by the above-described method has improved mechanical strength without impairing its dielectric properties compared with the use of a conventional siloxane polymer.

Preferred examples of the salt of the cage compound include compounds represented by the following structural formula (2):

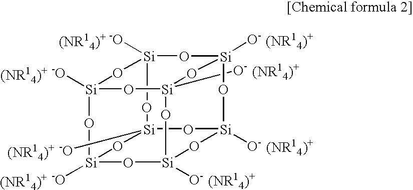

(wherein, R¹s may be the same or different and each independently represents a linear or branched C₁₋₄ alkyl group). These compounds can be obtained by an industrially stable method and can provide a siloxane polymer having good properties.

In the above-described hydrolysis and condensation reactions, a quaternary ammonium hydroxide may further be added as a basic catalyst and a siloxane polymer prepared using it has also good properties.

As the quaternary ammonium hydroxide, especially preferred are compounds represented by the following formula (3):

(R²)₄N⁺OH⁻ (3)

(wherein, R² may be the same or different and each independently represents a linear or branched C₁₋₈ alkyl group and the total number of carbon atoms of all the alkyl substituents R² of the counter cation [(R²)₄N⁺] is greater than the average number of the carbon atoms of all the alkyl substituents per counter cation of the salt of a silsesquioxane cage compound). A siloxane polymer having good properties is available by using this catalyst in combination.

The hydrolysable silane compound used in the preparation method of a siloxane polymer according to the invention preferably contains at least one hydrolyzable silane compound selected from compounds represented by the following formulas (4) and (5):

Si(OR³)₄ (4)

R⁴Si(OR⁵)₃ (5)

(wherein, R³s may be the same or different and each independently represents a linear or branched C₁₋₄ alkyl group, R⁴ represents a linear or branched C₁₋₈ alkyl group and R⁵s may be the same or different and each independently represents a linear or branched C₁₋₄ alkyl group).

In another aspect of the invention, there is also provided a siloxane polymer prepared by the above preparation method. A porous film having high mechanical strength can be obtained by applying a porous-film forming composition containing the siloxane polymer prepared by the method for preparing a siloxane polymer of the invention.

In a further aspect of the present invention, there is also provided a porous-film forming composition comprising the siloxane polymer. In a similar manner to that employed for the conventionally known siloxane polymer, the siloxane polymer of the invention is treated, for example, used in combination with a coating solvent, whereby the porous-film forming composition can be obtained.

In a still further aspect of the invention, there is also provided a porous film obtained by applying the porous-film forming composition on a substrate and then sintering. Compared with the mechanical strength and dielectric properties of a film obtained using a conventional material, the porous film of the invention has improved mechanical strength without deteriorating the dielectric properties.

In a still further aspect of the invention, there is also provided a method for forming a porous film comprising applying the composition on a substrate to form a thin film and then sintering the thin film.

In a still further aspect of the invention, there is also provided a semiconductor device comprising a porous film obtained by applying the composition on a substrate and then sintering. In a still further aspect of the invention, there is also provided a method for manufacturing a semiconductor device comprising applying the composition on a substrate to form a thin film and then sintering the thin film. Due to high mechanical strength of the resulting porous film, the semiconductor device available by this method can have high reliability.

Use of the porous film of the invention enables a drastic reduction in the parasitic capacitance of interconnects.

When the porous film of the invention is used as a insulating film for interconnection, there does not occur a conventional problem, that is, an increase in the dielectric constant due to hygroscopicity of porous films stacked to fabricate a multilevel interconnect. As a result, the semiconductor device can be operated at high speed and low power consumption.

In addition, since the porous film of the invention has high mechanical strength, the semiconductor device using it has improved mechanical strength. This leads to improvement in the production yield and reliability of the semiconductor device.

### BRIEF DESCRIPTION OF THE DRAWINGS

FIG. 1 is a schematic cross-sectional view illustrating one example of a semiconductor device of the invention; and

FIG. 2 is a graph in which a correlation between dielectric constant and mechanical strength is plotted.

### DETAILED DESCRIPTION OF THE PREFERRED EMBODIMENT(S)

The present invention now will be described more fully hereinafter in which embodiments of the invention are provided with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs.

Hereinafter, preferred embodiments of the present invention will be described. However, it is to be understood that the present invention is not limited thereto.

The siloxane polymer of the present invention is available by reacting a hydrolyzable silane compound with a salt of a silsesquioxane cage compound represented by the following formula (1):

(SiO_{1.5}—O)ₙⁿ⁻X⁺ₙ (1)

(wherein, X represents NR₄, Rs may be the same or different and each independently represents a linear or branched C₁₋₄ alkyl group and n is an integer from 8 to 24).

As the silsesquioxane cage compound, oligomers from hexamer to tetracosamer, of which hexamer to dodecamer are shown below, are known as the cage compound having a relatively stable structure from the thermodynamic viewpoint. Of these, the octamer is typical.

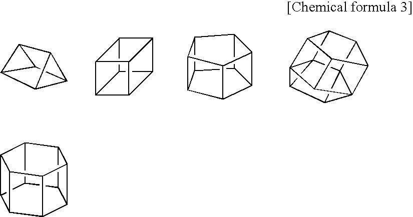

(wherein, a silicon atom is located at each vertex and each side represents an Si—O—Si bond). The silicon atom at each vertex of the above-described structures has one more remaining bonding site. When the remaining bonding site has a hydroxyl group as a substituent, it is acidic as silanol. A salts formed by this acidic hydroxyl group with a quaternary ammonium is the salt of a silsesquioxane cage compound.

It is known that a tetraalkylammonium salt of the silsesquioxane cage compound (octamer) can be synthesized by reacting powders of silica such as tetraalkoxysilane or Aerosil (trade name) with a tetraalkylammonium hydroxide in a water-containing solvent. This method is described, for example, in E. Muller, F. T. Edelmann, Main Group Metal Chemistry, 22, 485 (1999) or M. Moran, et al., Organometallics, 4327 (1993). A tetramethylammonium salt (60 hydrate) of the octamer is commercially available, for example, from Hybrid Plastics Inc.

The salt of a silsesquioxane cage compound can be isolated as crystals by selecting a proper reaction solvent. Crystals thus obtained are typically a polyhydrate of an octamer having an equilateral octahedral structure as shown below.

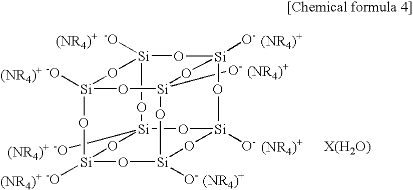

The reaction mixture contains, in addition, a decamer and a dodecamer, but they are trace components which cannot be isolated easily. For example, the decamer has the following structure:

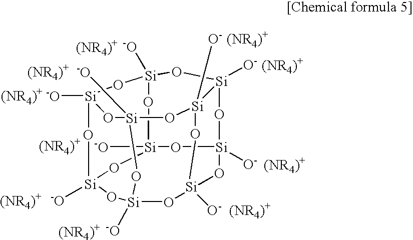

These salts of the silsesquioxane cage compound will be a silicon source of the siloxane polymer of the invention. Since they are the salts between weakly acidic silanol and a strongly basic quaternary ammonium salt, they exhibit therefore strongly basic properties and act as a catalyst for the hydrolysis and condensation reactions of a hydrolyzable silane in the presence of water.

As the hydrolyzable silane compounds to be used for the reaction with the salt of a silsesquioxane cage compound, any of many known materials capable of providing a siloxane polymer suitable for a porous low-dielectric-constant material can be used except for silane halides which generate a large amount of a neutral salt and need pretreatment for avoiding deactivation of the salt of a cage compound. Preferred examples of the hydrolyzable silane compound include silane compounds represented by the following formula (4) or (5):

Si(OR³)₄ (4)

R⁴Si(OR⁵)₃ (5)

(wherein, R³s may be the same or different and each independently represents a linear or branched C₁₋₄ alkyl group, R⁴ represents a linear or branched C₁₋₈ alkyl croup and R⁵s may be the same or different and each independently represents a linear or branched C₁₋₄ alkyl group). The hydrolyzable silane compound to be used for the reaction is preferably composed mainly of at least one compound selected from the compounds represented by the formulas (4) or those represented by the formula (5). A tetravalent hydrolyzable silane compound is effective for improving the strength of a siloxane polymer in a sintering process and a trivalent hydrolyzable silane compound contributes to the hydrophobicity of the resulting porous film so that use of at least one tetravalent hydrolyzable silane compound and at least one trivalent hydrolyzable silane compound in combination enables formation of a porous film having desirable properties. Specific examples of the compound represented by the formula (4) include tetramethoxysilane, tetraethoxysilane, tetrapropoxysilane, tetrabutoxysilane, tetraisopropoxysilane, tetraisobutoxysilane, triethoxymethoxysilane, tripropoxymethoxysilane, tributoxymethoxysilane, trimethoxyethoxysilane, trimethoxypropoxysilane and trimethoxybutoxysilane.

Examples of the silane compounds represented by the formula (5) include methyltrimethoxysilane, methyltriethoxysilane, methyltri-n-propoxysilane, methyltri-i-propoxysilane, methyltri-n-butoxysilane, methyltri-s-butoxysilane, methyltri-i-butoxysilane, methyltri-t-butoxysilane, ethyltrimethoxysilane, ethyltriethoxysilane, ethyltri-n-propoxysilane, ethyltri-i-propoxysilane, ethyltri-n-butoxysilane, ethyltri-s-butoxysilane, ethyltri-i-butoxysilane, ethyltri-t-butoxysilane, n-propyltrimethoxysilane, n-propyltriethoxysilane, n-propyltri-n-propoxysilane, n-propyltri-i-propoxysilane, n-propyltri-n-butoxysilane, n-propyltri-s-butroxysilane, n-propyltri-i-butoxysilane, n-propyltri-n-butoxysilane, i-propyltrimethoxysilane, i-propyltriethoxysilane, i-propyltri-n-propoxysilane, i-propyltri-i-propoxysilane, i-propyltri-n-butoxysilane, i-propyltri-s-butoxysilane, i-propyltri-i-butoxysilane, i-propyltri-t-butoxysilane, n-butyltrimethoxysilane, n-butyltriethoxysilane, n-butyltri-n-propoxysilane, n-butyltri-i-propoxysilane, n-butyltri-n-butoxysilane, n-butyltri-s-butoxysilane, n-butyltri-i-butoxysilane, n-butyltri-t-butoxysilane, i-butyltrimethoxysilane, i-butyltriethoxysilane, i-butyltri-n-propoxysilane, i-butyltri-i-propoxysilane, i-butyltri-n-butoxysilane, i-butyltri-s-butoxysilane, i-butyltri-i-butoxysilane, i-butyltri-t-butoxysilane, s-butyltrimethoxysilane, s-butyltriethoxysilane, s-butyltri-n-propoxysilane, s-butyltri-i-propoxysilane, s-butyltri-n-butoxysilane, s-butyltri-s-butoxysilane, s-butyltri-i-butoxysilane, s-butyltri-t-butoxysilane, t-butyltrimethoxysilane, t-butyltriethoxysilane, t-butyltri-n-propoxysilane, t-butyltri-i-propoxysilane, t-butyltri-n-butoxysilane, t-butyltri-s-butoxysilane, t-butyltri-i-butoxysilane, t-butyltri-t-butoxysilane, dimethyldimethoxysilane, dimethyldiethoxysilane, dimethyldi-n-propoxylsilane, dimethyldi-i-propoxysilane, dimethyldi-n-butoxysilane, dimethyldi-s-butoxysilane, dimethyldi-i-butoxysilane, dimethyldi-t-butoxysilane, diethyldimethoxysilane, diethyldiethoxysilane, diethyldi-n-propoxylsilane, diethyldi-i-propoxysilane, diethyldi-n-butoxysilane, diethyldi-s-butoxysilane, diethyldi-i-butoxysilane, diethyldi-t-butoxysilane, di-n-propyldimethoxysilane, di-n-propyldiethoxysilane, di-n-propyldi-n-propoxylsilane, di-n-propyldi-i-propoxysilane, di-n-propyldi-n-butoxysilane, di-n-propyldi-s-butoxysilane, di-n-propyldi-i-butoxysilane, di-n-propyldi-t-butoxysilane, di-i-propyldimethoxysilane, di-i-propyldiethoxysilane, di-i-propyldi-n-propoxylsilane, di-i-propyldi-i-propoxysilane, di-i-propyldi-n-butoxysilane, di-i-propyldi-s-butoxysilane, di-i-propyldi-i-butoxysilane, di-i-propyldi-t-butoxysilane, di-n-butyldimethoxysilane, di-n-butyldiethoxysilane, di-n-butyldi-n-propoxylsilane, di-n-butyldi-i-propoxysilane, di-n-butyldi-n-butoxysilane, di-n-butyldi-s-butoxysilane, di-n-butyldi-i-butoxysilane, di-n-butyldi-t-butoxysilane, di-i-butyldimethoxysilane, di-i-butyldiethoxysilane, di-i-butyldi-n-propoxylsilane, di-i-butyldi-i-propoxysilane, di-i-butyldi-n-butoxysilane, di-i-butyldi-s-butoxysilane, di-i-butyldi-i-butoxysilane, di-i-butyldi-t-butoxysilane, di-s-butyldimethoxysilane, di-s-butyldiethoxysilane, di-s-butyldi-n-propoxylsilane, di-s-butyldi-i-propoxysilane, di-s-butyldi-n-butoxysilane, di-s-butyldi-s-butoxysilane, di-s-butyldi-i-butoxysilane, di-s-butyldi-t-butoxysilane, di-t-butyldimethloxysilane, di-t-butyldiethoxysilane, di-t-butyldi-n-propoxylsilane, di-t-butyldi-i-propoxysilane, di-t-butyldi-n-butoxysilane, di-t-butyldi-s-butoxysilane, di-t-butyldi-i-butoxysilane, di-t-butyldi-t-butoxysilane, trimethylmethoxysilane, trimethylethoxysilane, trimethyl-n-propoxysilane, trimethyl-i-propoxysilane, trimethyl-n-butoxysilane, trimethyl-s-butoxysilane, trimethyl-i-butoxysilane, trimethyl-t-butoxysilane, triethylmethoxysilane, triethylethoxysilane, triethyl-n-propoxylsilane, triethyl-i-propoxysilane, triethyl-n-butoxysilane, triethyl-s-butoxysilane, triethyl-i-butoxysilane, triethyl-t-butoxysilane, tri-n-propylmethoxysilane, tri-n-propylethoxysilane, tri-n-propyl-n-propoxysilane, tri-n-propyl-i-propoxysilane, tri-n-propyl-n-butoxysilane, tri-n-propyl-s-butoxysilane, tri-n-propyl-i-butoxysilane, tri-n-propyl-t-butoxysilane, tri-i-propylmethoxysilane, tri-i-propylethoxysilane, tri-i-propyl-n-propoxylsilane, tri-i-propyl-i-propoxysilane, tri-i-propyl-n-butoxysilane, tri-i-propyl-s-butoxysilane, tri-i-propyl-i-butoxysilane, tri-i-propyl-t-butoxysilane, tri-n-butylmethoxysilane, tri-n-butylethoxysilane, tri-n-butyl-n-propoxylsilane, tri-n-butyl-i-propoxysilane, tri-n-butyl-n-butoxysilane, tri-n-butyl-s-butoxysilane, tri-n-butyl-i-butoxysilane, tri-n-butyl-t-butoxysilane, tri-i-butylmethoxysilane, tri-i-butylethoxysilane, tri-i-butyl-n-propoxylsilane, tri-i-butyl-i-propoxysilane, tri-i-butyl-n-butoxysilane, tri-i-butyl-s-butoxysilane, tri-i-butyl-i-butoxysilane, tri-i-butyl-t-butoxysilane, tri-s-butylmethoxysilane, tri-s-butylethoxysilane, tri-s-butyl-n-propoxylsilane, tri-s-butyl-i-propoxysilane, tri-s-butyl-n-butoxysilane, tri-s-butyl-s-butoxysilane, tri-s-butyl-i-butoxysilane, tri-s-butyl-t-butoxysilane, tri-t-butylmethoxysilane, tri-t-butylethoxysilane, tri-t-butyl-n-propoxylsilane, tri-t-butyl-i-propoxysilane, tri-t-butyl-n-butoxysilane, tri-t-butyl-s-butoxysilane, tri-t-butyl-i-butoxysilane, and tri-t-butyl-t-butoxysilane.

According to the method of the invention, the silane compounds may be used either singly or in combination. A hydrolyzable silane compound other than the above-described silane compounds may be added.

Examples of such a hydrolyzable silane compound to be used additionally include, but not limited to, divalent hydrolyzable silane compounds such as dimethyldimethoxysilane and dimethyldiethoxysilane and hydrolyzable silane compounds having plural silicon atoms such as hexamethoxydisiloxane, methylenebistrimethoxysilane, methylenebistriethoxysilane, 1,3-propylenebistrimethoxysilane, 1,4-(butylene)bistrimethoxysilane and 1,4-phenylenebistrimethoxysilane. Such a silane compound is added in an amount of preferably 30 mmole % or less.

It is not clear why a siloxane polymer shows high mechanical strength as described later by the reaction between the salt of a silsesquioxane cage compound and the hydrolyzable silane compound. Though any explanation or conclusion on the mechanism as described herein does not limit the technical scope of the invention, the present inventors think that the salt of a cage compound becomes a nucleus for the growth of a siloxane polymer, which may be one reason for high mechanical strength. High mechanical strength may be attributable only to a steric stable partial structure of the film.

As described above, however, the salt of a cage compound has an active structure in which silicon atoms constituting the vertices of a cage structure have a quaternary ammonium salt of silanol so that it has a high catalytic action for hydrolysis and condensation reactions at respective sites and in addition, has affinity with a silanol-containing monomer. It has therefore an activity of incorporating therein hydrolyzed hydroxysilane and condensing with it at high efficiency. Moreover, the reaction product thereof may also have the catalytic action and affinity for such hydrolyzed hydroxysilanes. Accordingly, the whole condensation reaction may proceed very efficiently with the salt of a cage compound as a reaction core. When such a reaction is repeated, there is a possibility of the reaction proceeding in a so-called low dispersion state, though the dispersibility of the siloxane polymer cannot easily be defined or determined. This may contribute to the improvement in the mechanical strength during film formation which will be described later.

In order to obtain a siloxane polymer having such physical properties, the salt of a silsesquioxane cage compound is added in an amount of preferably from 0.0001 to 1 mole, more preferably from 0.001 to 1 mole, per mole of the hydrolyzable silane compound. Amounts of the salt less than the above range do not bring about sufficient effects, while amounts exceeding the range are economically disadvantageous.

In the synthetic method of the siloxane polymer according to the invention, it is also possible to raise a condensation rate with a basic catalyst for promoting the hydrolysis of a hydrolyzable silane compound insofar as it does not impair the characteristics of the reaction attributable to the salt of the silsesquioxane cage compound. Examples of such bases may include amines such as ammonia, methylamine, dimethylamine, trimethylamine, ethylamine, diethylamine, triethylamine, propylamine, dipropylamine, tripropylamine, diisobutylamine, butylamine, dibutylamine, tributylamine, triethanolamine, pyrrolidine, piperidine, morpholine, piperazine, pyridine, pyridazine, pyrimidine, pyrazine and triazine; quaternary ammonium hydroxides such as tetramethylammonium hydroxide, tetraethylammonium hydroxide, tetrapropylammonium hydroxide, tetrabutylammonium hydroxide and choline; and hydroxides of an alkali metal or an alkaline earth metal such as sodium hydroxide, potassium hydroxide and calcium hydroxide.

When a weak base having low condensation activity is used, the amount of the basic catalyst for promoting hydrolysis of a hydrolyzable silane compound does not have a close relationship with the amount of the salt of a silsesquioxane cage compound. Amounts of the basic catalyst up to 500 moles per mole of the hydrolyzable silane compound do not pose any problem.

When a basic catalyst having high condensation activity is used in a large amount, on the other hand, due to the condensation activity as described above, there is a potential danger that a portion whose reaction proceeds independently from the salt of a cage compound increases, though a condensation reaction basically proceeds preferentially between a hydrolyzable silane and a cage compound or between the hydrolyzable silane and an intermediate obtained by the condensation reaction between the cage compound and silane. When a quaternary ammonium hydroxide such as tetramethylammonium hydroxide, tetraethylammonium hydroxide, tetrapropylammonium hydroxide, tetrabutylammonium hydroxide or choline, or a hydroxide of an alkali metal or alkaline earth metal such as sodium hydroxide, potassium hydroxide or calcium hydroxide is used, its amount is preferably adjusted to up to about 100 moles, more preferably up to about 30 moles per mole of the salt of a cage compound (hydrate salt).

If a siloxane polymer is obtained by the reaction in the combination of two quaternary ammoniums having different structure each other, wherein one of the ammonium derives from a counter cation of the salt of a silsesquioxane cage compound and another derives from a quaternary ammonium hydroxide from the ammonium, particularly in the case that the latter quaternary ammonium cation has a higher lipophilicity than the former quaternary ammonium cation, the film obtained from such siloxane polymer shows good mechanical strength, while the reason is unclear. The term “having higher lipophilicity” specifically means that the number of carbon atoms of the alkyl group which the ammonium cation has is greaten What is meant by “the counter cation of the quaternary ammonium hydroxide added separately has higher lipophilicity than the counter cation of the salt of a silsesquioxane cage compound” is that the total number of carbon atoms of all the alkyl groups substituted for a counter cation nitrogen of the quaternary ammonium hydroxide is greater than an average of the total number of carbon atoms of all the alkyl groups substituted for one counter cation nitrogen of the salt of a cage compound. Examples of the quaternary ammonium hydroxide having a counter cation with higher lipophilicity than the compounds represented by the formulas (1) and (2) include a compound represented by the following formula (3):

(R²)₄N⁺OH⁻ (3)

(wherein R² may be the same or different and each independently represents a linear or branched C₁₋₈ alkyl group and the total number of carbon atoms of all the alkyl substituents R² of the counter cation [(R²)₄N⁺] is greater than the average number of carbon atoms of all the alkyl substituents per counter cation of the salt of a silsesquioxane cage compound).

When the counter cation of the salt of a silsesquioxane cage compound is tetramethylammonium, specific examples of the quaternary ammonium hydroxide to be preferably used in combination include ethyltrimethylammonium hydroxide and tetrapropylammonium hydroxide. Reaction using such a combination of catalysts is effective insofar as it is used within a range not causing the undesirable state as described above.

The hydrolysis and condensation reactions for hydrolyzing the salt of a silsesquioxane cage compound and hydrolyzable silane compound to prepare a siloxane polymer are performed in the presence of water necessary for hydrolysis, but another solvent may be used for these reactions in addition to water. Examples include methanol, ethanol, isopropyl alcohol, butanol, propylene glycol monomethyl ether and propylene glycol monopropyl ether. Additional examples include acetone, methyl ethyl ketone, tetrahydrofuran, acetonitrile, formamide, dimethylformamide, dimethylacetamide and dimethylsulfoxide. The amount of water for hydrolysis is preferably from 0.5 to 100 moles, more preferably from 1 to 10 moles per mole necessary for complete hydrolysis of the hydrolyzable silane compound. When another solvent is used in addition to water, an amount of the solvent other than water is preferably from 1 to 1000 times, more preferably from 2 to 100 times the mass of the silane compound.

The time of hydrolysis and condensation reactions of the silane compound is preferably from 0.01 to 100 hours, more preferably from 0.1 to 50 hours, while the temperature of the hydrolysis and condensation reactions is preferably from 0 to 100° C., more preferably from 10 to 80° C.

As a post treatment after completion of the reactions, it is preferred to protect the surface active silanol as disclosed in Japanese Patent Provisional Publication No. 2004-292642 in order to maintain crosslinkability during film formation of a siloxane polymer closely related to mechanical strength. Described specifically, the active silanol is protected by adding a divalent or polyvalent carboxylic acid compound after the neutralization reaction of the basic catalyst but before the disappearance of the crosslinkability, more preferably immediately after the neutralization reaction or by carrying out the neutralization reaction itself with a divalent or polyvalent carboxylic acid, thereby carrying out neutralization and silanol protection simultaneously, whereby the crosslinkability can be lost until the decomposition of the carboxylic acid compound at the time of film formation.

Preferred examples of the carboxylic acid having, in the molecule thereof, at least two carboxyl groups include oxalic acid, malonic acid, malonic anhydride, maleic acid, maleic anhydride, fumaric acid, glutaric acid, glutaric anhydride, citraconic acid, citraconic anhydride, itaconic acid, itaconic anhydride and adipic acid. Such a carboxylic acid acts effectively when added in an amount ranging from 0.05 mole % to 10 mole %, preferably from 0.5 mole % to 5 mole % based on the silicon unit.

Salts generated during the neutralization operation, unnecessary water soluble substances, and metal impurities which may be mixed in can be removed by washing with water after a solvent immiscible with water is added. Examples of the solvent used for such a purpose include pentane, hexane, benzene, toluene, methyl ethyl ketone, methyl isobutyl ketone, 1-butanol, ethyl acetate, butyl acetate and isobutyl acetate.

The siloxane polymer thus prepared is dissolved in a solvent suited for application and provided as a solution. Examples of the solvent used for such a purpose include aliphatic hydrocarbon solvents such as n-pentane, isopentane, n-hexane, isohexane, n-heptane, 2,2,2-trimethylpentane, n-octane, isooctane, cyclohexane and methylcyclohexane; aromatic hydrocarbon solvents such as benzene, toluene, xylene, ethylbenzene, trimethylbenzene, methylethylbenzene, n-propylbenzene, isopropylbenzene, diethylbenzene, isobutylbenzene, triethylbenzene, diisopropylbenzene and n-amylnaphthalene; ketone solvents such as acetone, methyl ethyl ketone, methyl n-propyl ketone, methyl n-butyl ketone, methyl isobutyl ketone, cyclohexanone, 2-hexanone, methylcyclohexanone, 2,4-pentanedione, acetonylacetone, diacetone alcohol, acetophenone, and fenthion; ether solvents such as ethyl ether, isopropyl ether, n-butyl ether, n-hexyl ether, 2-ethylhexyl ether, dioxolane, 4-methyldioxolane, dioxane, dimethyldioxane, ethylene glycol mono-n-butyl ether, ethylene glycol mono-n-hexyl ether, ethylene glycol monophenyl ether, ethylene glycol mono-2-ethylbutyl ether, ethylene glycol dibutyl ether, diethylene glycol monomethyl ether, diethylene glycol dimethyl ether, diethylene glycol monoethyl ether, diethylene glycol diethyl ether, diethylene glycol monopropyl ether, diethylene glycol dipropyl ether, diethylene glycol monobutyl ether, diethylene glycol dibutyl ether, tetrahydrofuran, 2-methyltetrahydrofuran, propylene glycol monomethyl ether, propylene glycol dimethyl ether, propylene glycol monoethyl ether, propylene glycol diethyl ether; propylene glycol monopropyl ether, propylene glycol dipropyl ether, propylene glycol monobutyl ether, dipropylene glycol dimethyl ether, dipropylene glycol diethyl ether, dipropylene glycol dipropyl ether and dipropylene glycol dibutyl ether, ester solvents such as diethyl carbonate, ethyl acetate, γ-butyrolactone, γ-valerolactone, n-propyl acetate, isopropyl acetate, n-butyl acetate, isobutyl acetate, sec-butyl acetate, n-pentyl acetate, 3-methoxybutyl acetate, methylpentyl acetate, 2-ethylbutyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, dipropylene glycol monomethyl ether acetate, dipropylene glycol monoethyl ether acetate, dipropylene glycol mono-n-butyl ether acetate, glycol diacetate, methoxytriglycol acetate, ethyl propionate, n-butyl propionate, isoamyl propionate, diethyl oxalate, di-n-butyl oxalate, methyl lactate, ethyl lactate, n-butyl lactate, n-amyl lactate, diethyl malonate, dimethyl phlthalate and diethyl phthalate; nitrogen-containing solvents such as N-methylformamide, N,N-dimethylformamide, acetamide, N-methylacetamide, N,N-dimethylacetamide, N-methylpropionamide, and N-methylpyrrolidone, and sulfur-containing solvents such as dimethyl sulfide, diethyl sulfide, thiophene, tetrahydrothiophene, dimethyl sulfoxide, sulfolane, and 1,3-propanesultone. These solvents may be used either singly or in combination.

The degree of dilution differs, depending on the viscosity or intended film thickness, but dilution is typically conducted so as to adjust the amount of the solvent to from 50 to 99 mass %, more preferably from 75 to 95 mass %.

As another material to be added to the film forming composition, a number of film forming aids including surfactants are known and basically, any of them can be added to the film forming composition of the invention. As the film forming aid, surfactants, silane coupling agents and radical generators described in, for example, Japanese Patent Provisional Publication No. 2001-354904 can be used.

A proportion of the film forming aid, if it is added, in the total solid content of the film forming composition of the invention is from 0.001 to 10 mass % in terms of a solid content.

As a silicon-based polymer component, a polysiloxane prepared by a method other than that described herein can be incorporated in the film-forming composition of the invention, but a proportion of such polysiloxane must be adjusted to 59% or less, preferably 20% or less in order to fulfill the advantage of the invention.

Among polysiloxanes prepared by a method other than that described herein which is miscible in a film-forming composition of the invention, following ones are preferred additives because they are not only useful as a binder or film forming aid but also can improve the binding force between siloxane polymers, thereby improving the mechanical strength of the film while keeping the dielectric constant of a film.

Polysiloxane compounds having the above-described function contain a high concentration of silanol groups. The polysiloxane compounds are synthesized in the following manner.

A starting material is a mixture of a hydrolyzable silane compound containing at least one tetrafunctional alkoxysilane compound represented by the following formula (6):

Si(OR⁶)₄ (6)

(wherein, R⁶s may be the same or different and each independently represents a linear or branched C₁₋₄ alkyl group) and at least one alkoxysilane compound represented by the following formula (7):

R⁷ₙSi(OR⁸)₄₋ₙ (7)

(wherein, R⁸(s) may be the same or different when there are plural R⁸s and each independently represents a linear or branched C₁₋₄ alkyl group, R⁷(s) may be the same or different when there are plural R⁷s and each independently represents a linear or branched C₁₋₄ alkyl group which may have a substituent, and n is an integer from 1 to 3).

A proportion of the compound of the formula (6) may be, in terms of silicon atoms, preferably 25 mole % or greater based on the total moles of the compounds (6) and (7).

Preferred examples of R⁷ of the silane compound (7) may include alkyl groups such as methyl, ethyl, n-propyl, iso-propyl, n-butyl, iso-butyl, sec-butyl, t-butyl, n-pentyl, 2-ethylbutyl, 3-ethylbutyl, 2,2-diethylpropyl, cyclopentyl, n-hexyl and cyclohexyl; alkenyl groups such as vinyl and allyl; alkynyl groups such as ethynyl; aryl groups such as phenyl and tolyl; aralkyl groups such as benzyl and phenethyl; and other unsubstituted monovalent hydrocarbon groups. They may each have a substituent such as fluorine. Of these, methyl, ethyl, n-propyl, iso-propyl, vinyl and phenyl groups are especially preferred.

As R⁶ and R⁸, those providing an alcohol, which appears as a by-product after hydrolysis, having a boiling point lower than that of water are preferred. Examples include methyl, ethyl, n-propyl and iso-propyl.

The polysiloxane compound can be obtained by hydrolyzing and condensing such a silane compound in the presence of an acid catalyst. In order to obtain a polysiloxane compound capable of strengthen a binding force between silica polymers, however, it is preferred not to perform hydrolysis and condensation reactions in the presence of an acid catalyst in a conventional manner but to perform these reactions under such conditions as to hydrate silanol generated during hydrolysis and thereby prevent gelation.

The method of obtaining the polysiloxane compound is performed under reaction control. The reaction control is necessary because in the hydrolysis and condensation reactions of the hydrolyzable silane compound in the presence of an acid catalyst, a hydrolysis speed is higher than a condensation speed so that when a trivalent or tetravalent hydrolyzable silane compound is used as a raw material, the concentration of active silanol groups in the reaction mixture becomes too high and a large amount of an active intermediate having reaction active sites is formed, which may cause gelation. For the reaction control to prevent gelation, either a method of controlling generation of silanol groups or a method of directly controlling a gelation reaction of silanol groups generated by hydrolysis is used. These two controlling methods differ in an addition manner of the hydrolyzable silane compound and an amount of water added for hydrolysis.

Of these two methods, the method of controlling generation of silanol groups is more typical. In condensation reaction in the presence of an acid catalyst under ordinary conditions, water is added dropwise to the reaction mixture containing the hydrolyzable silane compound. This makes it possible to provide a sufficient time for silanol groups generated by hydrolysis to be consumed for condensation reaction, control a rise in the concentration of silanol groups and thereby prevent gelation. In addition, gelation is prevented by using a larger amount of an organic solvent having a relatively low polarity while decreasing the total amount of water, thereby avoiding contact between water and the hydrolyzable silane compound and condensing the silanol groups while storing the alkoxy group without causing an abrupt increase in the concentration of the silanol groups. In the particular case where no organic solvent is used, an amount of water must be adjusted so as not to exceed 1 mole per 1 mole of a hydrolyzable group in the hydrolyzable silane compound. Even in the typical case where an organic solvent is used, an amount of water is often adjusted similarly so as not to exceed 1 mole of a hydrolyzable group in the hydrolyzable silane compound. Apart from actual use, an upper limit of the amount of water is at most three times or five times larger than the amount necessary for hydrolysis in a patent literature which has a large margin. If the amount of water exceeded 1 mole per 1 mole of a hydrolyzable group in the actual use as described above, there is a risk of gelation. When water is added in an amount of two times the amount necessary for hydrolysis of all hydrolyzable groups, a polysiloxane compound cannot be taken out from the reaction mixture due to gelation thereof. In addition, the polysiloxane compound is synthesized while suppressing an increase in the concentration of silanol groups so that its content is low. For example, preparation of a polysiloxane compound in an amount of 5 mole % or greater, in terms of entire silicon atoms, usually leads to gelation.

The method of directly controlling a gelation reaction is on the other hand characterized by the use of a large excess of water. Active silanol groups are hydrated with a large excess of water, whereby the gelation reaction is controlled. More preferably, hydrolysis is performed using a large excess of water instead of using a large amount of an organic solvent which disturbs hydration. In the ordinary reaction operation, the hydrolyzable silane compound is charged in a reaction mixture of hydrolysis which constantly contains water in an amount exceeding the molar equivalent of the hydrolyzable groups already charged. It is more common to charge a large excess of water and an acid catalyst in a reaction tank in advance and add the hydrolyzable silane compound dropwise thereto. Such a design enables prompt hydration of silanol groups generated by the hydrolysis. Although a large amount of silanol groups is generated in the reaction mixture, sufficient hydration always proceed due to existence of a large amount of water and as a result of control of the activity of the silanol groups by hydration, gelation is prevented. Moreover, a polysiloxane compound available by this method is known to have, in the molecule thereof a high content of silanol groups.

In the above-described method, an amount of water used for hydrolysis of the monomer must be, at the same time, sufficient for hydrating the silanol groups generated in the reaction system. It is preferred to add the water in an amount of 3 moles or greater, preferably 5 moles or greater, per mole of the hydrolyzable group contained in the monomer. Gelation can usually be prevented by the addition of water in an amount greater than 5 moles. Described specifically, assuming that the lower limit of the preferred amount of water is 5 moles as described above and the upper limit is 100 moles as described later, each per mole of the hydrolyzable group contained in the monomer, when a polysiloxane compound is prepared from the tetravalent hydrolyzable silane compound of the formula (1) and the trivalent compound, among the compounds represented by the formula (2), the following relationship holds:

100×(4×Q+3×T)≧X≧5×(4×Q+3×T)

(wherein Q represents the mole of the compound of the formula (1), T represents the mole of the compound of the formula (2), and X represents the mole of water). By carrying out hydrolysis and condensation reactions in the presence of an acid catalyst while using such a large amount of water, a polysiloxane compound having a high silanol content is available without causing gelation. Addition of water in an amount exceeding 100 moles may be uneconomical because it only enlarges an apparatus used for reactions, though depending on the amount, and raises a cost for drainage treatment.

As the acid catalyst, any known ones are basically usable by properly adjusting the reaction conditions. Use of a catalyst selected from organic sulfonic acids which are said to be strongly acidic among organic acids, and inorganic acids which are said to be more strongly acidic is preferred to allow hydrolysis and condensation reactions to proceed completely. Examples of the inorganic acids include hydrochloric acid, sulfuric acid, nitric acid, and perchloric acid, while those of the organic sulfonic acids include methanesulfonic acid, tosic acid and trifluoromethanesulfonic acid. The amount of the strong acid used as the catalyst is from 10⁻⁶ moles to 1 mole, preferably 10⁻⁵ to 0.5 mole, more preferably 10⁻⁴ to 0.3 mole per mole of the silicon-containing monomer.

A divalent organic acid may be added further in order to heighten the stability of the polysiloxane compound during the reaction. Examples of such an organic acid include oxalic acid, malonic acid, methylmalonic acid, ethylmalonic acid, propylmalonic acid, butylmalonic acid, dimethylmalonic acid, diethylmalonic acid, succinic acid, methylsuccinic acid glutaric acid adipic acid itaconic acid, maleic acid, fumaric acid, and citraconic acid. Of these oxalic acid and maleic acid are especially preferred. An amount of the organic acid other than the organic sulfonic acid is from 10⁻⁶ moles to 10 moles, preferably 10- to 5 moles, more preferably 10⁻⁴ to 1 mole per mole of the silicon-containing monomer.

The hydrolysis and condensation reactions are started by dissolving the catalyst in water and then adding the monomer to the resulting solution. At this time, an organic solvent may be added to the aqueous solution of the catalyst or the monomer may be diluted in advance with the organic solvent. The reaction temperature is from 0 to 100° C., preferably from 10 to 80° C. It is also preferred to keep the temperature in the range from 10 to 50° C. during dropwise addition of the monomer and then ripen the reaction mixture in the range from 20 to 80° C.

Preferred examples of the organic solvent include methanol, ethanol, 1-propanol, 2-propanol, 1-butanol, 2-butanol, 2-methyl-1-propanol, acetone, acetonitrile, tetrahydrofuran, toluene, hexane, ethyl acetate, cyclohexanone, methyl-2-n-amylketone, propylene glycol monomethyl ether, ethylene glycol monomethyl ether, propylene glycol monoethyl ether, ethylene glycol monoethyl ether, propylene glycol dimethyl ether, diethylene glycol dimethyl ether, propylene glycol monomethyl ether acetate, propylene glycol monoethyl ether acetate, ethyl pyruvate, butyl acetate, methyl 3-methoxypropionate, ethyl 3-ethoxypropionate, tert-butyl acetate, tert-butyl propionate, propylene glycol mono-tert-butyl ether acetate, and γ-butyrolactone, and mixtures thereof.

Of these solvents, water soluble ones are preferred. Examples include alcohols such as methanol, ethanol, 1-propanol and 2-propanol, polyols such as ethylene glycol and propylene glycol, polyol condensate derivatives such as propylene glycol monomethyl ether, ethylene glycol monomethyl ether, propylene glycol monoethyl ether, ethylene glycol monoethyl ether, propylene glycol monopropyl ether, and ethylene glycol monopropyl ether, acetone, acetonitrile and tetrahydrofuran.

The organic solvent added in an amount of 50 mass % or greater hinders progress of hydrolysis and condensation reactions so that the amount must be less than 50 mass %. Per mole of the monomer, preferably from 0 to 1,000 ml of the organic solvent is added. Use of a large amount of the organic solvent is uneconomical because it requires an unnecessarily large reactor. The amount of the organic solvent is preferably 10 mass % or less based on water. It is most preferred to perform the reaction without the organic solvent.

The hydrolysis and condensation reactions are, if necessary, followed by the neutralization reaction of the catalyst. In order to smoothly conduct the following extraction operation further, the alcohol generated during the hydrolysis and condensation reactions is preferably removed under reduced pressure to obtain an aqueous solution of the reaction mixture. The amount of an alkaline substance necessary for the neutralization is preferably from 1 to 2 equivalents of the inorganic acid or organic sulfonic acid. As the alkaline substance, any substance is usable insofar as it is alkaline in water. Heating temperature of the reaction mixture varies, depending on the kind of the alcohol to be removed, but preferably from 0 to 100° C., more preferably from 10 to 90° C., still more preferably from 15 to 80° C. The degree of vacuum varies, depending on the kind of the alcohol to be removed, exhaust apparatus, condensing apparatus or heating temperature, but is preferably not greater than atmospheric pressure, more preferably an absolute pressure of 80 kPa or less, still more preferably an absolute pressure of 50 kPa or less. It is difficult to know the precise amount of the alcohol to be removed, but about at least 80 mass % of the alcohol generated during the reactions is preferably removed.

In order to remove the catalyst used for the hydrolysis and condensation reactions from the aqueous solution, the polysiloxane compound is extracted with an organic solvent. As the organic solvent, those capable of dissolving therein the polysiloxane compound and separating a mixture with water into two layers are preferred. Examples include methanol, ethanol, 1-propanol, 2-propanol, 1-butanol, 2-butanol, 2-methyl-1-propanol, acetone, tetrahydrofuran, toluene, hexane, ethyl acetate, cyclohexanone, methyl-2-n-amylketone, propylene glycol monomethyl ether, ethylene glycol monomethyl ether, propylene glycol monoethyl ether, ethylene glycol monoethyl ether, propylene glycol monopropyl ether, ethylene glycol monopropyl ether, propylene glycol dimethyl ether, diethylene glycol dimethyl ether, propylene glycol monomethyl ether acetate, propylene glycol monoethyl ether acetate, ethyl pyruvate, butyl acetate, methyl 3-methoxypropionate, ethyl 3-ethoxypropionate, tert-butyl acetate, tert-butyl propionate, propylene glycol mono-tert-butyl ether acetate, γ-butyrolactone, methyl isobutyl ketone and cyclopentyl methyl ether, and mixtures thereof.

Mixtures of a water soluble organic solvent and a hardly-water-soluble organic solvent are especially preferred. Preferred examples of the combination include, but not limited to, methanol+ethyl acetate, ethanol+ethyl acetate, 1-propanol+ethyl acetate, 2-propanol+ethyl acetate, propylene glycol monomethyl ether+ethyl acetate, ethylene glycol monomethyl ether+ethyl acetate, propylene glycol monoethyl ether+ethyl acetate, ethylene glycol monoethyl ether+ethyl acetate, propylene glycol monopropyl ether+ethyl acetate, ethylene glycol monopropyl ether+ethyl acetate, methanol+methyl isobutyl ketone, ethanol+methyl isobutyl ketone, 1-propanol+methyl isobutyl ketone, 2-propanol+methyl isobutyl ketone, propylene glycol monomethyl ether+methyl isobutyl ketone, ethylene glycol monomethyl ether+methyl isobutyl ketone, propylene glycol monoethyl ether+methyl isobutyl ketone, ethylene glycol monoethyl ether+methyl isobutyl ketone, propylene glycol monopropyl ether+methyl isobutyl ketone, ethylene glycol monopropyl ether+methyl isobutyl ketone, methanol+cyclopentyl methyl ether, ethanol+cyclopentyl methyl ether, 1-propanol+cyclopentyl methyl ether, 2-propanol+cyclopentyl methyl ether, propylene glycol monomethyl ether+cyclopentyl methyl ether, ethylene glycol monomethyl ether+cyclopentyl methyl ether, propylene glycol monoethyl ether+cyclopentyl methyl ether, ethylene glycol monoethyl ether+cyclopentyl methyl ether, propylene glycol monopropyl ether+cyclopentyl methyl ether, ethylene glycol monopropyl ether+cyclopentyl methyl ether, methanol+propylene glycol methyl ether acetate, ethanol+propylene glycol methyl ether acetate, 1-propanol+propylene glycol methyl ether acetate, 2-propanol+propylene glycol methyl ether acetate, propylene glycol monomethyl ether+propylene glycol methyl ether acetate, ethylene glycol monomethyl ether+propylene glycol methyl ether acetate, propylene glycol monoethyl ether+propylene glycol methyl ether acetate, ethylene glycol monoethyl ether+propylene glycol methyl ether acetate, propylene glycol monopropyl ether+propylene glycol methyl ether acetate, and ethylene glycol monopropyl ether+propylene glycol methyl ether acetate.

The mixing ratio of the water soluble organic solvent and the hardly-water-soluble organic solvent is determined as needed, but the water soluble organic solvent is added in an amount of 0.1 to 1000 parts by mass, preferably from 1 to 500 parts by mass, more preferably from 2 to 100 parts by mass, based on 100 parts by mass of the hardly-water-soluble organic solvent.

The organic layer obtained after the removal of the catalyst used for the hydrolysis and condensation reactions is mixed in a porous-film-forming composition after partial distillation of the solvent under reduced pressure and solvent substitution by re-dilution.

An undesirable impurity which is thought to be a microgel is sometimes mixed in the reaction mixture due to fluctuations in the conditions during hydrolysis reaction or concentration. The microgel can be removed by washing with water prior to mixing the polysiloxane compound in the composition. When washing with water is not so effective for the removal of the microgel, this problem may be overcome by washing the polysiloxane compound with acidic water and then with water.

The acidic water usable for the above purpose contains preferably a divalent organic acid, more specifically, oxalic acid or maleic acid. The concentration of the acid contained in the acidic water is from 100 ppm to 25 mass %, preferably from 200 ppm to 15 mass %, more preferably from 500 ppm to 5 mass %. The amount of the acidic water is from 0.01 to 100 L, preferably from 0.05 to 50 L, more preferably from 0.1 to 5 L per L of the polysiloxane compound solution obtained in the above-described step. The organic layer may be washed in a conventional manner. Both of them are charged in the same container, stirred, and left to stand to separate a water layer from the mixture. The washing may be performed at least once. Washing ten times or more does not bring about reasonable effects so that the washing is performed preferably from once to about five times.

The acid used for washing is then removed by washing with neutral water. It is only necessary to use, for this washing, water called deionized water or ultrapure water. The neutral water is used in an amount of 0.01 to 100 L, preferably from 0.05 to 50 L, more preferably from 0.1 to 5 L per L of the polysiloxane compound solution washed with the acidic water. The washing is performed in the above-described manner, more specifically, by charging them in the same container stirring the resulting mixture and leaving it to stand to separate a water layer from the mixture. The washing may be performed at least once. Washing ten times or more does not bring about reasonable effects so that the washing is performed preferably from once to about five times.

To the polysiloxane compound solution which has finished washing, a solvent for preparing a coating composition, which will be described later, is added. By performing solvent exchange under reduced pressure, a mother liquid to be added to the porous-film-forming composition can be obtained. This solvent exchange may be carried out after addition of silicon oxide fine particles which will be described later. The solvent exchange is conducted at a temperature which varies, depending on the kind of the extraction solvent to be removed, but is preferably from 0 to 10° C., more preferably from 10 to 90° C., still more preferably from 15 to 80° C. The degree of vacuum varies depending on the kind of the extraction solvent to be removed, exhaust gas apparatus, condensing apparatus or heating temperature, but is preferably not greater than the atmospheric pressure, more preferably an absolute pressure of 80 kPa or less, still more preferably an absolute pressure of 50 kPa or less.

When the solvent is exchanged, nanogel may be generated due to loss of stability of the polysiloxane compound. The generation of the nanogel depends on the affinity between the final solvent and polysiloxane compound. An organic acid may be added to prevent the generation of it. As the organic acid, divalent ones such as oxalic acid and maleic acid, and monovalent carboxylic acids such as formic acid, acetic acid and propionic acid are preferred. The amount of the organic acid is from 0 to 25 mass %, preferably from 0 to 15 mass %, more preferably from 0 to 5 mass % based on the polymer in the solution before the solvent exchange. When the organic acid is added, its amount is preferably 0.5 mass % or greater. If necessary, the acid may be added to the solution before the solvent exchange and then, solvent extraction operation may be performed.

As described above, the polysiloxane compound obtained in the above-described method can have, in the molecule thereof a greater amount of silanol groups than that obtained by the conventional method using hydrolysis and condensation reactions Described specifically, when the polysiloxane compound is composed of units represented by the following formulas:

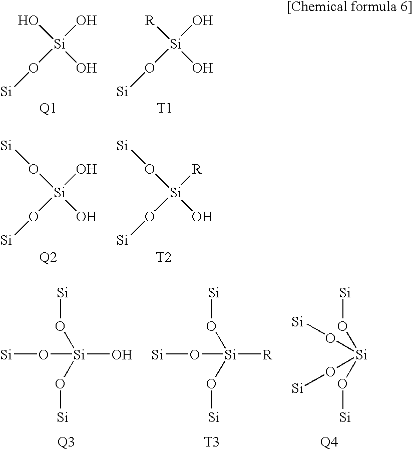

(wherein, Q means a unit derived from a tetravalent hydrolyzable silane, T means a unit derived from a trivalent hydrolyzable silane, and R in T1 to T3 indicates that a bond represented by Si—R is a bond between silicon and a carbon substituent), component ratios (molar ratios) (q1 to q4, t1 to t3) of the units (Q1 to Q4, T1 to T3) in the polysiloxane compound which is determined by ²⁹Si—NMR satisfies the following relationships:

(q1+q2+t1)/(q1+q2+q3+q4+t1+t2+t3)≦0.2 and

(q3+t2)/(q1+q2+q3+q4+t1+t2+t3)≧0.4.

The polysiloxane compound which can satisfy the above-described relationships has a function of improving the binding force between the above-described siloxane polymers.

If the condensation rate of the polysiloxane compound is calculated on the basis of a remaining amount of silanol groups or an alkoxy groups (both groups are generically referred to as “hydrolyzable group”), a polysiloxane compound having a silanol content of mole % or greater in terms of silicon atoms is available by the above-described method. Use of such a polysiloxane compound can improve the binding force between siloxane compounds.

When the polysiloxane compound obtained in the above-described method is added, a film forming composition is obtained by mixing a solution of this polysiloxane compound in a coating solvent with the above-described solution containing the siloxane polymer of the invention while adjusting the viscosity and the like as described above.

After preparation of a porous-film-forming composition in the above-described manner, the composition is spin coated onto a target substrate at an adequate rotation speed while controlling the solute concentration of the composition, whereby a thin film having a desired thickness can be formed.

A thin film having a thickness of about 0.1 to 1.0 μm is typically formed in practice, but the film thickness is not limited thereto. A thin film with a greater thickness can be formed by carrying out coating of the composition plural times.

Not only spin coating but also another application method such as scan coating can be employed.

A thin film thus formed can be converted into a porous film in a known manner Described specifically, the porous film is available as a final product by removing the solvent from the thin film by using an oven in a drying step (typically called pre-sintering step in a semiconductor fabrication process) to heat it to preferably from 50 to 150° C. for several minutes and then sintering it in the range from 350 to 450° C. for from about 5 minutes to 2 hours. A curing step with ultraviolet radiation or electron beam may be added further.

A semiconductor device having the porous film is also one of the inventions.

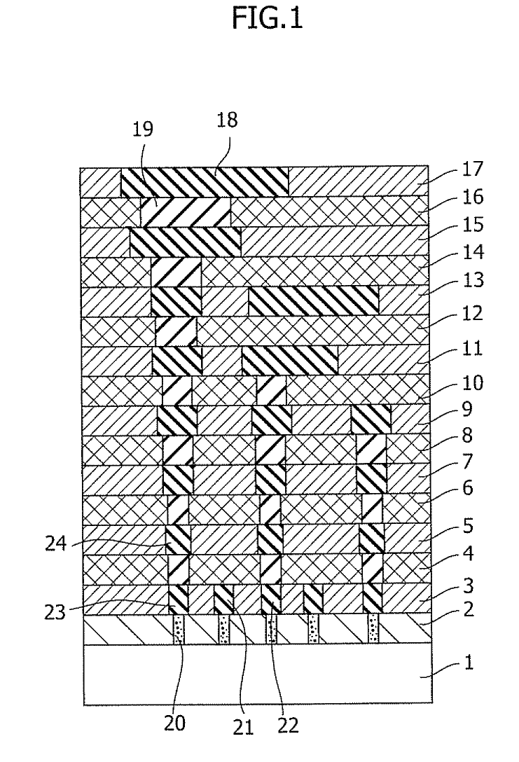

One embodiment of the semiconductor device of the invention will next be described based on FIG. 1.

As substrate 1, Si semiconductor substrates such as Si substrate and SOI (Si On Insulator) substrate can be employed. Alternatively, it may be a compound semiconductor substrate such as SiGe or GaAs.

Interlayer insulating films illustrated in FIG. 1 are interlayer insulating film 2 of a contact layer, interlayer insulating films 3, 5, 7, 9, 11, 13, 15, and 17 of interconnect layers, and interlayer insulating films 4, 6, 8, 10, 12, 14, and 16 of via layers. The term “interlayer insulating film” as used herein may mean a film for electrically insulating conductive sites present in a layer or a film for electrically insulating conductive sites present in different layers. Examples of the conductive sites include metal interconnects.

The interconnect layers from the interlayer insulating film 3 of the lowermost interconnect layer to the interlayer insulating film 17 of the uppermost interconnect layer are referred to as M1, M2, M3, M4, M5, M6, M7 and M8, respectively in the order from the bottom to the top.

The layers from the interlayer insulating film 4 of the lowermost via layer to the interlayer insulating film 16 of the uppermost via layer are referred to as V1, V2, V3, V4, V5, V6 and V7, respectively in the order from the bottom to the top.

Some metal interconnects are indicated by numerals 18 and 21 to 24, respectively, but even if such a numeral is omitted, portions with the same pattern as that of these interconnects illustrate metal interconnects.

A via plug 19 is made of a metal and it is typically copper in the case of a copper interconnect. Even if a numeral is omitted, portions with the same pattern as that of these via plugs illustrate via plugs.

A contact plug 20 is connected to a gate of a transistor (not illustrated) formed on the uppermost surface of the substrate 1 or to the substrate.

As illustrated, the interconnect layers and the via layers are stacked alternately. The term “multilevel interconnects” typically means M1 and layers thereabove. The interconnect layers M1 to M3 are typically called local interconnects; the interconnect layers M4 to MS are typically called intermediate or semi-global interconnects; and the interconnect layers M6 to M8 are typically called global interconnects.

In the semiconductor device illustrated in FIG. 1, the porous film of the invention is used as at least one of the interlayer insulating films 3, 5, 7, 9, 11, 13, 15, and 17 of the interconnect layers and the interlayer insulating films 4, 6, 8, 10, 12, 14 and 16 of the via layers.

For example, when the porous film of the invention is used as the interlayer insulating film 3 of the interconnect layer (M1), a capacitance between the metal interconnect 21 and metal interconnect 22 can be reduced greatly. When the porous film of the invention is used as the interlayer insulating film 4 of the via layer (VI), a capacitance between the metal interconnect 23 and metal interconnect 24 can be reduced greatly. Thus, use of the porous film of the invention having a low dielectric constant for an interconnect layer enables drastic reduction of the capacitance between metal connects in the same layer. In addition, use of the porous film of the invention having a low dielectric constant for the via layer enables drastic reduction in the capacitance between metal interconnects above and below a via layer. Accordingly, use of the porous film of the invention for all the interconnect layers and via layers enables great reduction in the parasitic capacitance of the interconnects.

In addition, use of the porous film of the invention as an insulating film for interconnection is free from a conventional problem, that is, an increase in a dielectric constant caused by moisture absorption of porous films during formation of multilevel interconnects by stacking them one after another. As a result, the semiconductor device featuring high speed operation and low power consumption can be obtained.

In addition, due to high strength of the porous film of the invention, the semiconductor device thus obtained has improved mechanical strength. As a result, the semiconductor device thus obtained has greatly improved production yield and reliability.

The present invention will hereinafter be described in detail by Examples. It should be noted that the scope of the invention is not limited to or by these Examples.

### Preparation Example 1

### Salt of a Silsesquioxane Cage Compound

To a mixture of 115.46 g of ultrapure water, 178.57 g of acetone and 72.92 g of a 25% aqueous solution of tetramethylammonium hydroxide, 115.46 g of tetraethoxysilane was added and the resulting mixture was stirred overnight. The liquid which was transparent first became turbid. The liquid was left to stand for one hour while cooling with ice water.

The reaction mixture was filtered. The residue was washed with cold water and air dried to yield 16.2 g of colorless crystals. It was confirmed by NMR measurements that the crystals were of a {(SiO_{1.5})—O—N(CH₃)₄}₈.80H₂O compound.

### Example 1

A solution obtained by mixing 188.4 g of ethanol, 93.44 g of ultrapure water and 5.26 g of the crystals obtained in Preparation Example 1 was heated to 60° C. under stirring. A mixture of 19.5 g of methyltrimethoxysilane and 36.43 g of tetraethoxysilane was added dropwise to the resulting solution over 6 hours. After cooling of the reaction mixture thus obtained to room temperature with ice water, 2 g of oxalic acid and 200 ml of propylene glycol monomethyl ether acetate [PGMEA] were added. The resulting solution was distilled by an evaporator to remove the solvent. The solvent was distilled off until the remaining solution became 216.8 g. To the remaining solution were added 200 g of ethyl acetate and 120 g of ultrapure water, and the resulting mixture was stirred and left to stand in a separating funnel. After the water layer thus separated was removed, the organic layer was washed twice with 120 ml of ultrapure water. After 120 ml of PGMEA was added to the organic layer thus obtained, the solvent was distilled off by an evaporator to concentrate the mixture into 229.69 g. As a result of gel permeation chromatography of the resulting solution, it had a molecular weight of 1,545,000, as a peak top, and Mw/Mn of 1,560. A nonvolatile residue was about 7 mass %. The concentrated solution was spin coated onto a silicon wafer for 1 minute at 4,000 rpm, followed by heating at 120° C. for 2 minutes, at 230° C. for 2 minutes and at 425° C. for 1 hour, whereby a porous film with about 300 nm thickness was obtained. The film had a dielectric constant of 2.12 and mechanical strength of 5.83 GPa.

### Example 2

In a similar manner to Example 1 except the raw material silane was added dropwise for 4 hours, the reaction was performed. The concentrated solution thus obtained had a mass of 200.76 g. The solution was spin coated onto a silicon wafer, followed by heating as in Example 1. The film thus obtained had a dielectric constant of 2.28 and mechanical strength of 7.62 GPa.

### Example 3

In a similar manner to Example 1 except that the raw material silane was added dropwise for 3 hours, the reaction was performed. The concentrated solution thus obtained had a mass of 245.17 g. The solution was spin coated onto a silicon wafer, followed by heating as in Example 1. The film thus obtained had a dielectric constant of 2.35 and mechanical strength of 8.36 GPa.

### Example 4

In a similar manner to Example 1 except that the raw material silane was added dropwise for 2 hours, the reaction was performed. The concentrated solution thus obtained had a mass of 211.07 g. The solution was spin coated onto a silicon wafer, followed by heating as in Example 1. The film thus obtained had a dielectric constant of 2.40 and mechanical strength of 9.35 GPa.

### Example 5

In a similar manner to Example 1 except the raw material silane was added dropwise for 1 hour, the reaction was performed. The concentrated solution thus obtained had a mass of 224.17 g. The solution was spin coated onto a silicon wafer, followed by heating as in Example 1. The film thus obtained had a dielectric constant of 2.44 and mechanical strength of 9.60 GPa.

### Example 6

In a similar manner to Example 1 except that 22.63 g of a 10% aqueous solution of tetrapropylammonium hydroxide and 3.56 g of the crystals obtained in Preparation Example 1 were used instead of 5.26 g of the crystals obtained in Preparation Example 1 and a mixture of 19.5 g of methyltrimethoxysilane and 36.43 g of tetraethoxysilane was added dropwise over 6 hours, the reaction was performed. The concentrated solution finally obtained had a mass of 215.18 g. The solution was spin coated onto a silicon wafer, followed by heating as in Example 1. The film thus obtained had a dielectric constant of 2.28 and mechanical strength of 9.58 GPa.

### Example 7

In a similar manner to Example 1 except for the use of 45 g of the reaction mixture obtained in Preparation Example 1 instead of the crystals obtained in Preparation Example 1, reaction was performed. The concentrated solution had a mass of 214.93 g. The solution was applied onto a silicon wafer and heated as in Example 1. The film thus obtained had a dielectric constant of 2.41 and mechanical strength of 7.98 GPa.

### Comparative Example 1

A solution obtained by mixing 188.4 g of ethanol, 93.44 g of ultrapure water and 8.26 g of 25% tetramethylammonium hydroxide was heated to 60° C. under stirring. A mixture of 19.5 g of methyltrimethoxysilane and 36.43 g of tetraethoxysilane was added dropwise to the resulting solution over 6 hours. After cooling of the reaction mixture thus obtained to room temperature with ice water, 2 g of oxalic acid and 200 ml of PGMEA were added. The resulting solution was distilled by an evaporator to remove the solvent. The solvent was distilled off until the remaining solution became 160.98 g. To the solution thus obtained were added 200 g of ethyl acetate and 120 g of ultrapure water and the resulting mixture was stirred and left to stand in a separating funnel. After the water layer thus separated was removed, the organic layer was washed twice with 120 ml of ultrapure water. After 120 ml of PGMEA was added to the organic layer thus obtained, the solvent was distilled off by an evaporator to concentrate the mixture into 207.84 g. As a result of gel permeation chromatography of the concentrated solution, it had a molecular weight of 1,535,000 as a peak top, and Mw/Mn of 83000. The solution was coated onto a silicon wafer and heated at 120° C. for 2 minutes, 230° C. for 2 minutes and 425° C. for 1 hour, whereby a porous film with about 300 nm thickness was obtained. The film had a dielectric constant of 2.17 and mechanical strength of 3.90 GPa.

### Comparative Example 2

In a similar manner to Comparative Example 1 except that the raw material silane was added dropwise for 4 hours instead of 6 hours, the synthesis was performed, whereby a concentrated solution of 203.91 g was obtained. The solution was applied onto a silicon wafer, followed by heating at 120° C. for 2 minutes, 230° C. for 2 minutes and 425° C. for 1 hour. The film thus obtained had a dielectric constant of 2.35 and mechanical strength of 5.70 GPa.

### Comparative Example 3

In a similar manner to Comparative Example 1 except that the raw material silane was added dropwise for 2 hours instead of 6 hours, the synthesis was performed, whereby 213.54 g of the concentrated solution was obtained. The solution was applied onto a silicon wafer, followed by heating at 120° C. for 2 minutes, 230° C. for 2 minutes and 425° C. for 1 hour. The film thus obtained had a dielectric constant of 2.50 and mechanical strength of 7.23 GPa.

### Comparative Example 4

In a similar manner to Comparative Example 1 except the raw material silane was added dropwise for 1 hour instead of 6 hours, the synthesis was performed, whereby 188.18 g of a concentrated solution was obtained. The solution was applied onto a silicon wafer, followed by heating at 120° C. for 2 minutes, 230° C. for 2 minutes and 425° C. for 1 hour. The film thus obtained had a dielectric constant of 2.82 and mechanical strength of 11.21 GPa.

### Comparative Example 5

A colorless transparent solution was obtained by adding 5.2 g of tetraethylsilane to 36.46 g of a 25% aqueous solution of tetramethylammonium hydroxide and stirring the mixture at room temperature for 18 hours. The resulting solution was confirmed to be a water-containing solution of tetrakistrimethylammonium silicate represented by Si(ON(CH₃)₄)₄. To the resulting solution were added 188.4 g of ethanol and 93.44 g of ultrapure water and the resulting mixture was stirred and heated to 60° C. A mixture of 21.66 g of methyltrimethylsilane and 33.12 g of triethylsilane was added dropwise over 3 hours. After the resulting solution was allowed to cool to 30° C., 2 g of oxalic acid and 200 ml of PGMEA were added. The solution was distilled by an evaporator to remove the solvent. Distillation was conducted until the residue became 187.3 g. To the solution thus obtained were added 200 g of ethyl acetate and 120 g of ultrapure water. The resulting mixture was stirred and left to stand in a separating funnel. After the water layer thus separated was removed, the organic layer was washed twice with 120 ml of ultrapure water. After 120 ml of PGMEA was added to the organic layer thus obtained, the solvent was distilled off by an evaporator to concentrate the solution into 220.86 g. As a result of analysis by gel permeation chromatography, the resulting concentrated solution had a molecular weight of 522,000, as a peak top, and Mw/Mn of 13,000. The solution was applied onto a silicon wafer, followed by heating at 120° C. for 2 minutes, 230° C. for 2 minutes and 425° C. for 1 hour, whereby a porous film with about 300 nm thickness was obtained. The film had a dielectric constant of 2.45 and mechanical strength of 6.52 GPa.

The physical properties of each of the porous films were measured by the following methods.

1. Dielectric constant was measure using “495-CV System” (product of SSM Japan) in accordance with C-V measurements with an automatic mercury probe.

2. Mechanical strength (modulus of elasticity) was measured using a nano indenter (product of Nano Instruments).

TABLE 1

| | | Mechanical |
|---|---|---|
| | Dielectric | strength |
| | constant | (GPa) |
| Example 1 | 2.21 | 5.83 |
| Example 2 | 2.28 | 7.62 |
| Example 3 | 2.35 | 8.36 |
| Example 4 | 2.4 | 9.35 |
| Example 5 | 2.44 | 9.6 |
| Example 6 | 2.28 | 9.58 |
| Example 7 | 2.41 | 7.98 |
| Comp. Ex. 1 | 2.17 | 3.9 |
| Comp. Ex. 2 | 2.35 | 5.7 |
| Comp. Ex. 3 | 2.5 | 7.23 |
| Comp. Ex. 4 | 2.82 | 11.21 |
| Comp. Ex. 5 | 2.45 | 6.52 |

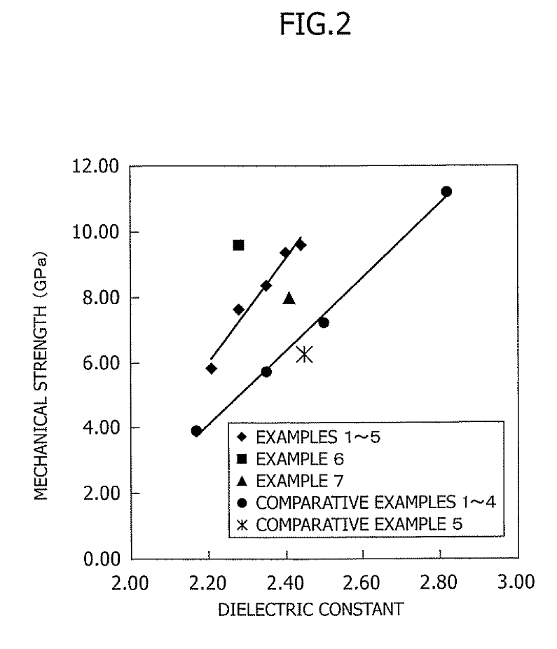

In a design of a low-dielectric-constant insulating film, it is only necessary to increase porosity in order to reduce its dielectric constant, for example, by adjusting the size of particles contained in a film forming composition so as to raise a void ratio or using a pore-forming agent such as porogen. If a film is made of the same material, however, there is a trade-off relationship between the porosity and mechanical strength. As actual examples in FIG. 2 show, there is typically a linear relationship, within a narrow range, that is, a range of a dielectric constant from 2 to 3, between a low dielectric constant and mechanical strength of films available from materials synthesized without changing the material and catalyst. In order to evaluate whether a low-dielectric-constant insulating film with high mechanical strength is formed or not, the mechanical strength relative to the dielectric constant must be compared between these films.

As is apparent from FIG. 2, the low-dielectric-constant insulating films of the invention obtained in Examples 1 to 5 each has higher mechanical strength at each dielectric constant compared with the mechanical strength/dielectric constant of films formed in a conventional manner using the siloxane polymers synthesized in Comparative Examples 1 to 4 and showing relatively high mechanical strength at each dielectric constant. This means that the low-dielectric-constant insulating films of the invention show improved mechanical strength compared with the low-dielectric-constant insulating film formed in a conventional manner when the dielectric constant is the same.

Moreover, the film obtained in Example 6 by using a quaternary ammonium which is a counter cation of the salt of a silsesquioxane cage compound and a quaternary ammonium hydroxide different therefrom in structure in combination as a basic catalyst shows further improvement in mechanical strength compared with the films obtained in Examples 1 to 5. The film obtained in Example 7 by using the salt of a silsesquioxane cage compound without isolation while generating it in a reaction system shows also higher mechanical strength than the films obtained in Comparative Examples. These results suggest that the films of the invention achieved the advantage of the invention.

The film obtained in Comparative Example 5 used a siloxane polymer obtained by condensation of a quaternary ammonium salt of silanol having no cage structure and a hydrolyzable silane compound. FIG. 2 suggests that the film did not achieve the advantage of the invention.

The method for preparing a siloxane polymer according to the invention is effective for obtaining a siloxane polymer useful for preparing a porous-film-forming composition capable of providing high mechanical strength.

The siloxane polymer of the invention is effective as a material for preparing a porous-film-forming composition for forming a low-dielectric-constant insulating film with high mechanical strength.

The porous-film-forming composition according to the invention is effective as a material for forming a low-dielectric-constant insulating film with high mechanical strength.

The method for forming a porous film according to the invention is effective for preparing a material for forming a low-dielectric-constant insulating film with high mechanical strength.

The porous film according to the invention is effective as a material for forming a low-dielectric-constant insulating film with high mechanical strength.

The semiconductor device according to the invention is effective as a high-performance semiconductor device capable of achieving high speed and low power consumption operation.

It is to be understood that the present invention is not limited to the embodiments given above. The embodiments given above are merely illustrative, and those having substantially the same configuration as the technical concept defined by the appended claims of the present invention and having similar functions and effects are considered to fall within the technical scope of the present invention.

1. A method for preparing a siloxane polymer by hydrolysis and condensation reactions of a hydrolyzable silane compound, which comprises preparing a salt of a silsesquioxane cage compound represented by the following formula (1):
(SiO_{1.5}—O)ₙⁿ⁻X⁺ₙ (1)
wherein, X represents NR₄, Rs may be the same or different and each independently represents a linear or branched C₁₋₄ alkyl group and n is an integer from 6 to 24 or an aqueous solution of the salt and hydrolyzing and condensing the hydrolyzable silane compound to a silanol terminal of the silsesquioxane cage compound.

2. A method for preparing a siloxane polymer according to claim 1, wherein the salt of a silsesquioxane cage compound is represented by the following structural formula (2): 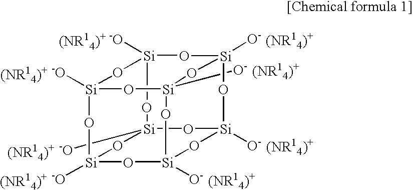
wherein, R's may be the same or different and each independently represents a linear or branched C₁₋₄ alkyl group.

3. A method for preparing a siloxane polymer according to claim 1 further comprising adding a quaternary ammonium hydroxide as a basic catalyst.

4. A method for preparing a siloxane polymer according to claim 3, wherein the quaternary ammonium hydroxide is a compound represented by the following formula (3):
(R²)₄N₊OH⁻ (3)
wherein, R²s may be the same or different and each independently represents a linear or branched C₁₋₈ alkyl group and the total number of carbon atoms of all the alkyl substituents R² of the counter cation [(R²)₄N⁺] is greater than the average number of carbon atoms of all the alkyl substituents per counter cation of the salt of a silsesquioxane cage compound.

5. A method for preparing a siloxane polymer according to claim 1, wherein the hydrolyzable silane compound is represented by the formula (4) or (5):
Si(OR³)₄ (4)
R⁴Si(OR⁵)₃ (5)
wherein, R³s may be the same or different and each independently represents a linear or branched C₁₋₄ alkyl group, R⁴ represents a linear or branched C₁₋₈ alkyl group and R⁵s may be the same or different and each independently represents a linear or branched C₁₋₄ alkyl group.

6. A siloxane polymer prepared using the preparation method of claim 1.

7. A composition for forming a porous film comprising the siloxane polymer of claim 6.

8. A porous film obtained by applying the composition of claim 7 onto a substrate and sintering.

9. A method for forming a porous film, comprising applying the composition of claim 7 onto a substrate to form a thin film and sintering the thin film.

10. A semiconductor device comprising a porous film obtained by applying the composition of claim 7 onto a substrate and sintering.

11. A method for manufacturing a semiconductor device, comprising applying a solution containing the composition of claim 7 onto a substrate to form a thin film and sintering the thin film.
